(19) United States
(12) Patent Application Publication
(10) Pub. No.: US 2013/0060578 A1
(43) Pub. Date: Mar. 7, 2013

(54) Creating and Retaining Medical Instructions for a Patient in a Telemedicine Environment

(71) Applicants: Doreen Lynn Galli, Dripping Springs, TX (US); Marc S. Galli, Dripping Springs, TX (US)

(72) Inventors: Doreen Lynn Galli, Dripping Springs, TX (US); Marc S. Galli, Dripping Springs, TX (US)

(73) Assignee: PATIENT FORWARD, LLC, Dripping Springs, TX (US)

(21) Appl. No.: 13/226,515

(22) Filed: Sep. 7, 2011

(51) Int. Cl. G06Q 50/22; G06Q 50/24

(52) U.S. Cl. 705/3; 705/2

(57) ABSTRACT

A technique for efficiently capturing and retaining patient instructions made by a physician or other medical provider. In a computer-based medical service system, a medical provider utilizes a medical provider portal to interact with the system and a patient utilizes a patient portal to interact with the system. During an appointment utilizing the system, the medical provider inputs medical instructions intended for the patient via the portal. If the patient is utilizing the patient portal during the appointment, a window opens in the patient portal and the instructions input by the medical provider are displayed therein. The instructions are retained and are accessible by the patient whenever the patient utilizes the patient portal. The instructions can have documents associated therewith by the medical services provider which can be attached to the instructions during or after the appointment.

### BACKGROUND OF THE INVENTION

1. Field of the Invention

The present invention relates to capturing medical directives or instructions in a telemedicine or computer-based medical system for retention and use by a patient. More particularly, the present invention relates to providing a medical professional with a technique for efficiently and effectively providing a patient with medical directives or instructions, and providing a patient with a technique for receiving and maintaining the medical directives or instructions.

2. Description of the Related Art

Recent technological advances are permitting the advent of telemedicine, wherein patients can visit a doctor without ever visiting a doctor=s or medical provider=s office. For example, U.S. Pat. No. 7,912,733 to Clements et al. describes a medical services delivery system that provides a telemedicine environment. Real time video images of a patient and a physician and online electronic medical records are utilized to allow a remote physician to perform remote patient medical service delivery.

However, existing telemedicine systems provide limited functionality and are geared toward the medical provider experience. The need exists for optimization of these systems to provide an enhanced patient experience.

A common problem that has been difficult to address in the medical delivery system prior to telemedicine systems still permeates the telemedicine environment. In a typical appointment, a patient explains her symptoms to her physician. Depending on the complaint, the physician may then examine the patient and/or ask a series of questions. Based on the complaint and the doctor=s analysis, the doctor may then order tests, provide advice, write a prescription and make notes for the patient=s medical record, provide the patient with verbal instructions, provide the patient with a brochure or written instructions, etc.

The weak link in this medical experience is often the patient and her memory. Patients typically do not take notes or record the doctor-patient interaction. A medical provider=s medical notes are typically not understandable by those who are not medical professionals, a group which includes most patients. Verbal instructions are often forgotten or misinterpreted. A medical provider will sometimes give a medical brochure, written instructions or an exercise instruction sheet for the patient to review after the appointment. But this only provides the patient with the needed information if the doctor has the required brochure or exercise instruction sheet in stock and accessible. Then the patient must keep track of the physical documents and have access to them when the patient has the time to read them.

U.S. Pat. No. 7,945,456 to Schoenberg provides one attempt to address this issue in a one type of telemedicine environment. The patent describes a telemedicine environment in which a patient has a non-office visit via a video link through computers with a medical provider who is typically not the patient=s normal medical provider. During the appointment, the system records the discussion between the patient and medical provider. If desired, the recorded discussion is sent to a third party, who creates a summary document from the recording. The summary document is then made available to the patient at some time after the appointment has finished.

This approach has a number of drawbacks. First, the approach requires the intervention of the third party to transcribe and summarize the discussion. This adds cost, raises privacy issues, and risks misinterpretation of the discussion by the third party. Second, this approach requires the patient to be able to review the document and understand what the important components of the discussion were. Depending on the length of the document, the skill of the transcriber, and whether the summary captures the important pieces of the discussion, the patient may or may not understand what she is supposed to understand. Add that the patent may not be sophisticated enough to understand the summary and the delivery of the summary document to the patient may or may not be timely, clearly there are many ways in which this approach may have fail to have the desired result.

Accordingly, a better information delivery system is needed to guarantee that a patient conveniently obtains and has access to the information that the medical services provider wants the patient to have that avoids the problems associated with the prior art.

### SUMMARY OF THE INVENTION

The present invention provides a technique for capturing patient instructions or directives made by a medical provider during a patient appointment and delivering them to a patient.

In one aspect, addressed in the present application, techniques are provided for programmatically providing a patient with pertinent medical information from a medical services provider, comprising establishing a communication over a network between a patient portal and a medical services provider portal, the patient interacting with the medical services provider through the patient portal and the medical services provider interacting with the patient through the medical services provider; creating, when the medical services provider selects a patient instructions option available on the medical services provider portal and inputs patient instructions, a set of patient instructions; and providing the patient instructions to the patient portal. In another aspect of the invention, the patient instructions are displayed to the patient via the patient portal. The patient instructions may be added to a patient medical record associated with the patient portal and accessible by the patient via the patient portal. The creating may further comprise the medical services provider selecting one or more medical documents from a set of available medical documents and inputting customized patient instructions to the medical services provider portal. The medical services provider portal may provide a list of documents that may be included in the patient instructions when the medical services provider selects the patient instructions option. The medical services provider may customize the selected documents.

Additionally, the technique may further comprise enabling the medical services provider to modify the patient instructions after the communication over the network has been terminated if the medical services provider selects an option provided on the medical services provider portal to modify the patient instructions; updating the patient instructions available to the patient to reflect the modified patient instructions; and alerting the patient that the patient instructions have been modified.

In another aspect, techniques are provided for programmatically permitting a medical services provider to create a permanent patient instruction or directive that is delivered to a patient. This aspect preferably comprises a computer program product residing on a computer readable medium for providing a patient with pertinent medical information from a medical services provider, the computer program product comprising instructions for causing a computer to establish a communication over a network between a patient portal and a medical provider portal, the patient interacting with the medical services provider via the patient portal and the medical services provider interacting with the patient through the medical services provider; create, when the medical services provider selects a patient instructions option available on the medical services provider portal and inputs patient instructions, a set of patient instructions; and provide the patient instructions to the patient portal

The present invention will now be described with reference to the following drawings, in which like reference numbers denote the same element throughout.

### BRIEF DESCRIPTION OF THE DRAWINGS

FIG. 1 provides a telemedicine environment in which the present invention may be practiced;

FIG. 2 illustrates a graphical user interface displayed at a medical services provider portal to a medical services provider,

FIG. 3 illustrates a graphical user interface displayed at a patient portal to a patient; and

FIG. 4 illustrates a flow chart describing the creation of a set of patient instructions according to the present invention.

### DESCRIPTION OF PREFERRED EMBODIMENTS

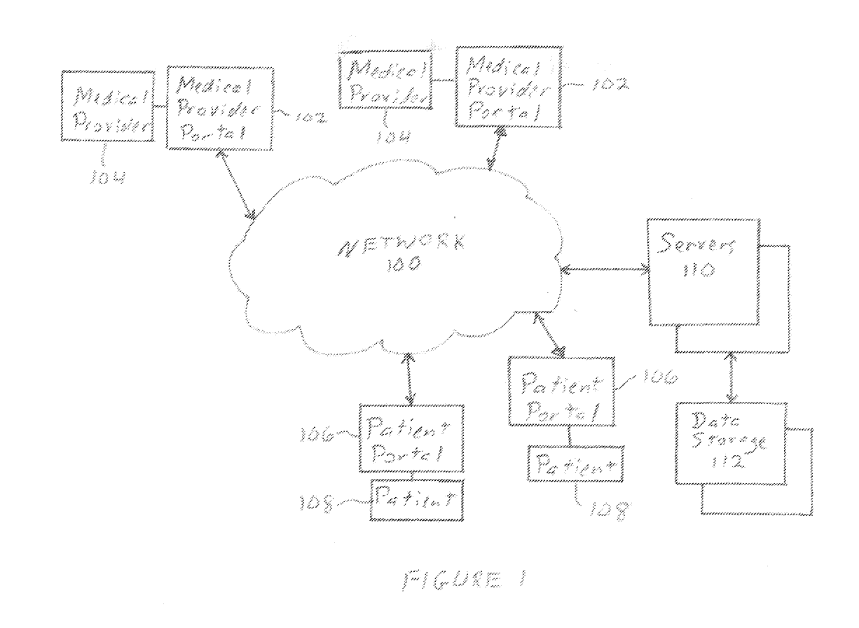

FIG. 1 illustrates a telemedicine environment or computer-based medical services system in which the present invention may be practiced. Preferably, the present invention utilizes the cloud computing concept, in that the telemedicine system operates as a service which is accessed via the Internet. Alternatively, in some environments, the network may be a local Intranet. In either case, a network 100 is utilized to enable communication between medical provider portals 102 to be utilized by medical service providers 104, patient portals 106 to be utilized by patients 108, and one or more servers 110. The servers 110 have data storage devices 112 associated therewith. Medical service providers and patients utilize web browsers at their point of access to the network 100 to access their respective portals 102 and 106, which are maintained by the servers 110 as part of a computer-based telemedicine web service.

While the video abilities associated with a telemedicine medical system may be utilized, they are not necessary to implement the invention. For example, if a two-way video link is not available, the link can be one way or there may be no video link at all, and the patient-medical service provider interaction can be conducted over a network utilizing audio only. Further, in case of an in person appointment, the patient need not be online or accessing her patient portal 106 at the time of the appointment. The medical provider instructions can be input by the medical services provider and accessed by the patient via the patient portal 106 at a later time when the patient is online and logged into the medical service system.

The medical service providers 104 and patients 108 utilize web browsers at their point of access to the network 100 to access their respective portals 102, 106, which are maintained by the servers 110 as part of the computer-based medical services system. The point of access can be one of many devices, including a laptop computer, personal computer, kiosk dedicated to providing a connection to the medical software, tablet, smart phone, or any device capable of an Internet connection and browsing the Internet. A web cam associated with the device to enable a video link is preferred, as the medical services system preferably includes the capability to enable a two way video link between users of the system in accordance with known techniques. While most devices do not require any software other than a standard web browser to be installed to work with the medical services system, some small devices having web browsers with limited functionality may require a local support application to be installed to enable some of the features of the medical services system.

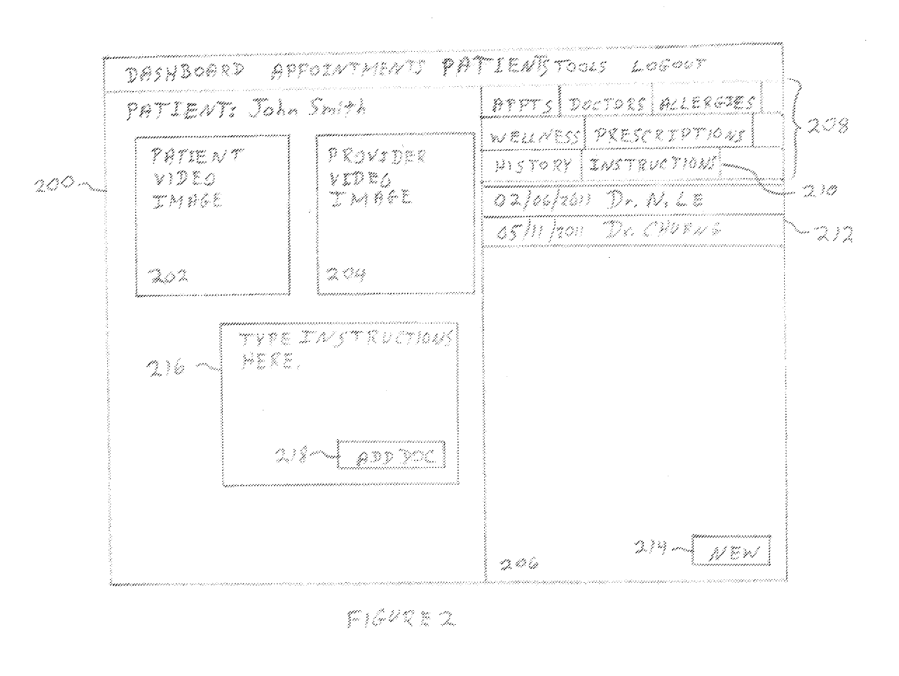

The portals 102, 106 provide their respective users with tools by which the users interact with the medical services system. Accordingly, when a medical provider utilizes a web browser on her device to access the medical service provider portal 102, a medical provider graphical user interface 200 is displayed, as illustrated in FIG. 2. Similarly, when a patient utilizes a web browser resident on his device to access the patient portal 106, a patient graphical user interface 300 is displayed, which is different than the medical provider graphical user interface 200. The medical provider portal 102 preferably provides all the tools needed by a medical services provider to provide a complete medical picture of a patient (if all the patient=s medical records, insurance information, etc. are accessible by the medical services system), as well as business or medical practice information relative to each patient and the daily work of the medical provider.

The patient portal 106 has the ability to provide a patient with her complete medical picture, from doctor information to appointment information to prescription information to medical history. The patient portal 106 provides patients with a single point of access at which all of their medical information can be maintained and accessed by the patients. In this way, a patient can have access to doctors names and contact information, current and historical appointment data, current and historical prescription information, insurance information, x-rays, allergy information, etc. In other words, a patient can have his complete medical history easily accessible, together with pertinent current medical/physician/prescription information.

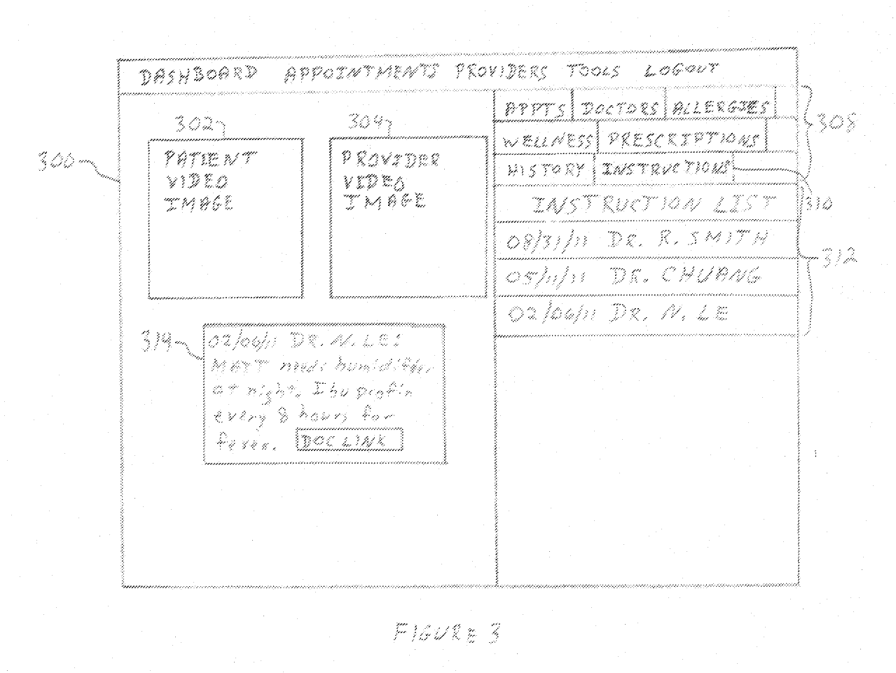

So while the medical provider portal 102 and the patient portal 106 differ in a number of ways, they do have a number of important similarities. As illustrated in FIGS. 2 and 3, preferably, one element of both graphical user interfaces 200, 300 is a pair of windows 202, 204 and 302, 304 for streaming live video, one for incoming and one for outgoing video. Live audio in connection with these windows is also provided, in accordance with known techniques. These permit the patient and medical provider to conduct remote >in person=appointments. Normally, the patient sees not only the medical provider but himself during an appointment. In this way, the patient sees not only the medical provider, but also what the doctor sees of himself. By the patient being able to see what the provider sees, in case the patient needs to show something to the provider, like a rash or a burn, etc., the patient can see what the provider is seeing and adjust the view to provide the provider with the best view possible. The option is available to add additional video windows so as to add more participants to an appointment if the situation requires more than two remote participants. For example, this might include multiple medical providers, a child and a parent who is remote, etc.

The point of access to the medical provider portal 102 or the patient portal 106 can be quite varied. As discussed above, any of a variety of devices that are capable of supporting a web browser may be utilized. For example, a patient may use a personal computer from home or work to access the patient portal 106. The video feature can be implemented using a web cam associated with the personal computer. However, access to the patient portal 106 can be executed with a variety of hardware devices having differing capabilities. For example, permanent, dedicated kiosks with high resolution cameras and controlled lighting may be utilized. Enabling a remote medical provider with the ability to control and zoom the camera can enhance the quality of a doctor-patient interaction. Such kiosks can be established to provide telemedicine appointments with high quality video to enable enhanced medical interactions. University health centers, workplaces, hospitals, doctors offices, and disaster zones and examples of places that can be set up with a specialized kiosk which includes secure access to the portal and a high resolution camera with zoom and quality lighting.

FIG. 2 illustrates one screen of the medical provider graphical user interface (GUI) 200 which is displayed to a medical services provider via the medical provider portal 102. The medical provider GUI 200 includes video windows 202 and 204 for displaying incoming and outgoing video images which the medical provider may utilize view a patient via a real time or near real time video image of a patient. The patient=s medical and related information is viewable in an information window 206. A set of tabs 208 associated with the information window 206 permit the medical services provider to quickly and efficiently find pertinent patient information. One of the tools provided to the medical services provider in the GUI 200 permits the medical services provider to create a set of directives or instructions for the patient. A medical service provider option to create patient directives may be implemented in a variety of ways in a graphical user interface. In the preferred embodiment, a directives or instructions tab 210 in the set of tabs 208 is provided, and is utilized to initiate the creation of a set of patient instructions, as described below.

Similarly to FIG. 2, FIG. 3 illustrates one screen of a patient graphical user interface 300 having video windows 302 and 304 for displaying incoming and outgoing video images which the patient may utilize during an appointment with a medical services provider to view a real time or near real time video image of a medical services provider and himself. An information window 306 is also provided so that the patient can view pertinent medical information. Patient medical information can be navigated utilizing a set of tabs 308 associated with the information window 306. Preferably, one of the tabs 308 is a medical instruction tab 310, which the patient may select to view instructions and directives given to the patient by a medical services provider. When the tab 310 is selected, a selectable instruction list 312 is displayed in the information window 306. The list 312 may be sorted based on date the instructions were created or updated or the name of the medical services provider who created the instructions.

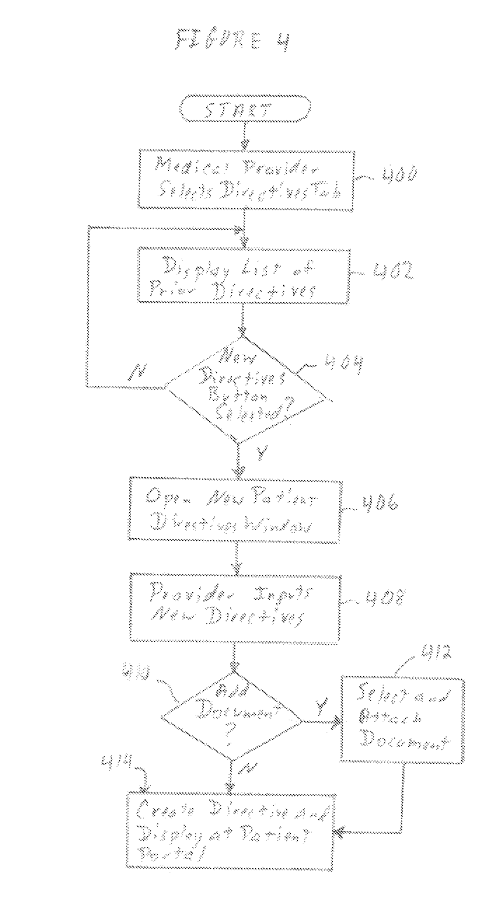

The creation of patient directives will now be described with respect to the flowchart of FIG. 4 and the graphical user interfaces illustrated in FIGS. 2 and 3.

When the medical provider selects the directives or instructions tab 210 from the set of tabs 208 associated with a particular patient (Step 400), a listing of prior patient directives 212 is displayed in the information window 206 together with a new directives button 214 (Step 402), which, when selected by the medical services provider (Step 404), initiates the process for creating a new set of patient directives. Upon selection, a new patient directives window 216 is opened (Step 406), into which the medical service provider inputs specific patient instructions or directives for the patient (Step 408). The instructions can be input in a number of known ways, such as through typing, speech recognition, etc.

Alternatively or additionally, the medical service provider may chose to attach a document or file into the set of patient instructions. Preferably, the new patient directives window 216 also includes an add document button 218. Upon selection of the add document button 218 (Step 410), a process is initiated for adding a medical document to the patient directives. This addition of a document can be done in accordance with known techniques, in that the medical provider can browse for an appropriate medical document to add to the patient instructions being created, either on the medical provider=s own computer, from the data storage devices 112 associated with the servers 110, etc. (Step 412). In this way, a medical document, such as a brochure for a medical condition or proposed medical test or the like will be instantly accessible by the patient whenever the patient is utilizing the patient portal 106.

When the medical provider has finished creating the new patient directives, the medical provider selects the finished button, which finishes the creation of the new patient directives. If the patient is currently logged into his patient portal 106, a patient directives window 314 is opened on the patient graphical user interface 300 and the newly created patient directive, with an indication of any attached document, is displayed (Step 414). In this way, the patient directives may be immediately reviewed by the patient and any questions can be asked of the medical provider at that time.

Should the medical provider wish to modify the patient directives at any time, the medical provider opens the list of patient directives for the appropriate patient, selects the patient directive from the displayed list of patient directives 212, which opens the patient directive and enables an edit mode. The medical provider can then modify the patient directive by changing the text or adding documents, as desired. The medical services system will then send a message to the patient in any of a number of known techniques, such as email, text message, message at the patient portal 106, etc., to inform the patient that a modified or new patient directive can be accessed via the patient portal 106.

As discussed above, if the patient is logged onto the patient portal 106 when the patient directive is created, a patient directive window 314 will pop open on the patient GUI 300. If the patient is not online when the patient directive is created or modified by the medical provider, a message will be delivered to the patient. The next time the patient logs onto the patient portal 106, the patient may select the medical instructions or directives tab 310 and open the appropriate instruction from the list of patient instructions 312 for review.

As will be appreciated by one of skill in the art, embodiments of the present invention may be provided as (for example) methods, systems, and/or computer program products. The present invention may take the form of an embodiment combining software and hardware aspects. Furthermore, the present invention may take the form of a computer program product which is embodied on one or more computer-usable storage media (including, but not limited to, disk storage, CD-ROM, optical storage, and so forth) having computer-usable program code embodied therein.

The present invention has been described with reference to flow diagrams and/or block diagrams according to embodiments of the invention. It will be understood that each flow and/or block of the flow diagrams and/or block diagrams, and combinations of flows and/or blocks in the flow diagrams and/or block diagrams, can be implemented by computer program instructions. These computer program instructions may be provided to a processor of a general purpose computer, special purpose computer, embedded processor, or other programmable data processing apparatus to produce a machine, such that the instructions, which execute the more processor of the computer or other programmable data processing apparatus, create means for implementing the functions specified in the flow diagram flow or flows and/or block diagram block or blocks.

These computer program instructions may also be stored in a computer-readable memory that can direct a computer or other programmable data processing apparatus to function in a particular manner, such that the instructions stored in the computer-readable memory produce an article of manufacture including instruction means which implement the function specified in the flow diagram flow or flows and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions specified in the flow diagram flow or flows and/or block diagram block or blocks.

While preferred embodiments of the present invention have been described, additional variations and modifications in those embodiments may occur to those skilled in the art once they learn of the basic inventive concepts. Therefore, it is intended that the appended claims shall be construed to include preferred embodiments and all such variations and modifications as fall within the spirit and scope of the invention.

What is claimed is:

1. A computer-implemented method for providing a patient with pertinent medical information from a medical services provider, comprising:
establishing a communication over a network between a patient portal and a medical provider portal, the patient interacting with the medical services provider via the patient portal and the medical services provider interacting with the patient through the medical services provider;
creating, when the medical services provider selects a patient instructions option available on the medical services provider portal and inputs patient instructions, a set of patient instructions; and
providing the patient instructions to the patient portal.

2. The computer-implemented method according to claim 1, further comprising:
displaying the patient instructions to the patient via the patient portal.

3. The computer-implemented method according to claim 1, further comprising:
adding the patient instructions to a patient medical record associated with the patient.

4. The computer-implemented method according to claim 1, wherein said creating further comprises the medical services provider selecting one or more medical documents from a set of available medical documents and adding the selected medical document to the patient instructions.

5. The computer-implemented method according to claim 1, wherein the medical provider portal provides a list of documents that may be included in the patient instructions when the medical services provider selects the patient instructions option.

6. The computer-implemented method according to claim 4, wherein the medical services provider may customize the selected documents.

7. The computer-implemented method according to claim 1, further comprising:
enabling the medical services provider to modify the patient instructions after the original patient instructions have been created and provided to the patient portal;
saving the modified patient instructions;
providing the modified patient instructions to the patient portal; and
alerting the patient that the modified patient instructions are available on the patient portal.

8. An apparatus comprising:
a processor; and
a computer program product residing on a computer readable medium for providing a patient with pertinent medical information from a medical services provider, the computer program product comprising instructions for causing the processor to:
establish a communication over a network between a patient portal and a medical provider portal, the patient interacting with the medical services provider via the patient portal and the medical services provider interacting with the patient through the medical services provider;
create, when the medical services provider selects a patient instructions option available on the medical services provider portal and inputs patient instructions, a set of patient instructions; and
provide the patient instructions to the patient portal.

9. A computer program product residing on a computer readable medium for providing a patient with pertinent medical information from a medical services provider, the computer program product comprising instructions for causing a computer to:
establish a communication over a network between a patient portal and a medical provider portal, the patient interacting with the medical services provider via the patient portal and the medical services provider interacting with the patient through the medical services provider;
create, when the medical services provider selects a patient instructions option available on the medical services provider portal and inputs patient instructions, a set of patient instructions; and
provide the patient instructions to the patient portal.
